(19) United States
(12) Patent Application Publication
(10) Pub. No.: US 2023/0212391 A1
(43) Pub. Date: Jul. 6, 2023

(54) THERMOPLASTIC RESIN COMPOSITION FOR LOW GLOSS NON-PAINTING, METHOD FOR MANUFACTURING MOLDED ARTICLE USING SAME, AND MOLDED ARTICLE

(71) Applicants: Hyundai Motor Company, Seoul (KR); Kia Corporation, Seoul (KR); Samyang Corporation, Seoul (KR)

(72) Inventors: Kyeong Hoon Jang, Seoul (KR); In Soo Han, Uiwang (KR); Seul Yi, Seoul (KR); Do Young Bae, Daejeon (KR); Suk Woo Kang, Wonju (KR); Tae Jin An, Seoul (KR); Jung Kyu Han, Sejong (KR)

(21) Appl. No.: 18/086,984

(22) Filed: Dec. 22, 2022

(30) Foreign Application Priority Data
Dec. 31, 2021 (KR) 10-2021-0193600

(51) Int. Cl. C08L 69/00; C08L 83/06; C08L 67/02

(52) U.S. Cl. CPC C08L 69/00; C08L 83/06; C08L 67/02; C08L 2205/035; C08L 2205/025

(57) ABSTRACT

Provided herein are a thermoplastic resin composition for a low gloss non-painting, a method for manufacturing a molded article using the same, and a molded article. The thermoplastic resin composition includes a first polycarbonate; a polysiloxane-polycarbonate copolymer; polyester; a master batch including carbon black; a heat resistance improver; and an additive. The molded article manufactured using the same has excellent chemical resistance, mechanical properties, light resistance, hydrolysis resistance, and low gloss properties.

### CROSS-REFERENCE TO RELATED APPLICATION

This application claims under 35 U.S.C. § 119(a) the benefit of priority to Korean Patent Application No. 10-2021-0193600 filed on Dec. 31, 2021, the entire contents of which are incorporated herein by reference.

### TECHNICAL FIELD

Provided is a thermoplastic resin composition for a low gloss non-painting, a method for manufacturing a molded article using the same, and a molded article. The thermoplastic resin composition may include a polycarbonate (first polycarbonate); a polysiloxane-polycarbonate copolymer; polyester; carbon black compounded as a master batch (MB); a heat resistance improver; and an additive. The molded article manufactured using the same may have substantially improved chemical resistance, mechanical properties, light resistance, hydrolysis resistance, and low gloss properties.

### BACKGROUND

Since a polycarbonate resin composition exhibits improved processability while maintaining excellent impact resistance, heat resistance, and mechanical strength, it has been generally widely used in automobile parts, computer housings, or housings of other office equipment, and due to the nature of these uses, painting properties and excellent processability are required.

Recently, there is an increasing demand for the development of materials which have various functionalities while having lightweight in the fields of automobiles, and electric and electronic and industrial material parts, and thus the utilization of resins such as plastic parts instead of conventional metal and cross-linked rubber parts is increasing. In particular, attempts have been made to improve the physical properties of polycarbonate by blending another thermoplastic resin with a polycarbonate (PC) resin having excellent mechanical properties, impact resistance, and heat resistance.

For example, a resin composition which has a low melt viscosity and improved ductility compared to polyalkylene terephthalate by mixing polycarbonate and polyalkylene terephthalate has been reported, but since the usability of the resin is poor, there are problems in that the composition becomes opaque, and the impact strength deteriorates.

Further, a resin composition formed of a copolyester essentially composed of repeated units induced from a mixture made of polycarbonate and isophthalic acid, terephthalic acid, and 1,4-cyclohexanedimethanol has been reported, but this composition cannot provide sufficient impact strength.

### SUMMARY

In preferred aspects, provided is a thermoplastic resin composition which satisfies mechanical properties such as impact resistance while having excellent heat resistance, exhibits chemical resistance, hydrolysis resistance, and light resistance. Thus, the resin composition may be applied into vehicle parts, e.g., automobile interior and exterior materials for non-painting with excellent injection appearance, and an automobile molded article.

The object of the present disclosure is not limited to the object mentioned above. The object of the present disclosure will become clearer from the following description, and will be realized by means and combinations thereof described in the claims.

In an aspect, provided is a thermoplastic resin composition including a first polycarbonate; a polysiloxane-polycarbonate copolymer; a polyester; a carbon black compounded as a master batch (MB): a heat resistance improver; and an additive.

The first polycarbonate may be a thermoplastic aromatic polycarbonate having a viscosity average molecular weight (Mv) of about 15,000 to 40,000.

The first polycarbonate may comprise a polymer of Chemical Formula 1 below.

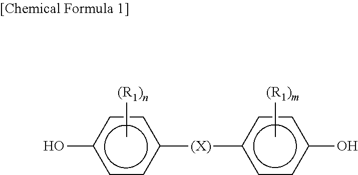

wherein in Chemical Formula 1:

X is a linear, branched or cyclic alkylene group, or comprises a linear, branched or cyclic alkylene group comprising a functional group selected from the group consisting of sulfide, ether, sulfoxide, sulfone, ketone, naphthyl, isobutylphenyl, and combinations thereof;

Each R₁ and R₂ is independently a hydrogen atom, a halogen atom, or an alkyl group; and

Each n and m is independently an integer of 0 to 4.

The polysiloxane-polycarbonate copolymer may suitably have a viscosity average molecular weight (Mv) of about 15,000 to 200,000 and comprise hydroxy-terminated siloxane and polycarbonate at a weight ratio of about 50:50 to 99:1.

The polysiloxane-polycarbonate copolymer may include polymers of Chemical Formulas 2 and 3 below.

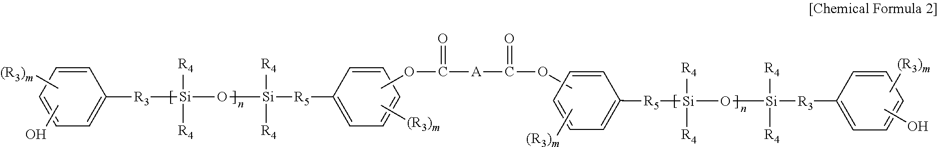

wherein in Chemical Formula 2:

each R₃ is independently a hydrogen atom, a halogen atom, a hydroxy group, an alkyl group having 1 to 20 carbon atoms, an alkoxy group having 1 to 13 carbon atoms, or an aryl group having 6 to 10 carbon atoms;

each R₄ is independently a hydrocarbon group having 1 to 13 carbon atoms or a hydroxy group;

each R₅ is independently an alkylene group having 2 to 8 carbon atoms; and

A is -X- or —NH—X—NH—, wherein X is a linear or branched aliphatic group having 1 to 20 carbon atoms, a cycloalkylene group having 3 to 6 carbon atoms, or a mononuclear or polynuclear arylene group having 6 to 30 carbon atoms unsubstituted or substituted with a halogen atom, an alkyl group, an alkoxy group, an aryl group, or a carboxyl group;

each m is independently an integer of 0 to 10, and

each n is independently an integer of 2 to 1,000.

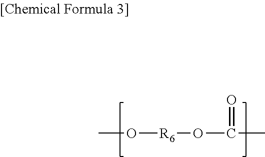

wherein in Chemical Formula 3:

R₆ is an alkyl group having 1 to 20 carbon atoms, a cycloalkyl group having 3 to 6 carbon atoms, an, alkenyl group having 2 to 13 carbon atoms, an alkoxy group having 1 to 13 carbon atoms or an aromatic hydrocarbon group having 6 to 30 carbon atoms unsubstituted or substituted with a halogen atom, or a nitro.

The polyester according to the present disclosure may have a melting temperature of about 215° C. to 235° C. and an intrinsic viscosity (IV) of about 0.45 dl/g to 1.6 dl/g.

The polyester may comprise one or more selected from the group consisting of polyethylene terephthalate, polypropylene terephthalate, and polybutylene terephthalate.

The master batch may comprise carbon black and a second polycarbonate.

The master batch may suitably include an amount of about 10% by weight to 40% by weight of carbon black and an amount of about 60% by weight to 90% by weight of the second polycarbonate, based on the total weight of the master batch.

The heat resistance improver may include an N-phenylmaleimide compound-vinyl aromatic compound-maleic anhydride copolymer.

The heat resistance improver may include an N-phenylmaleimide compound-vinyl aromatic compound-maleic anhydride copolymer, and the N-phenylmaleimide compound-vinyl aromatic compound-maleic anhydride copolymer may suitably include an amount of about 44 to 65% by weight of an N-phenylmaleimide compound, an amount of about 34 to 55% by weight of a vinyl aromatic compound, and an amount of about 0.5 to 5% by weight of maleic anhydride, based on the total weight of the heat resistance improver.

The additive may comprise a gloss reducing agent and an impact modifier.

The gloss reducing agent may suitably include an ASA-based graft copolymer having a core-shell structure, the ASA-based graft copolymer may suitably include an amount of about 30 to 80% by weight of a core and an amount of about 20 to 70% by weight of a shell, based on the total weight of the ASA-based graft copolymer. The core of the ASA-based graft copolymer may include an acrylic rubber, and wherein the shell of the ASA-based graft copolymer may comprise a vinyl-based graft copolymer.

The impact modifier may suitably include an MBS-based graft copolymer having a core-shell structure, wherein the core of the MBS-based graft copolymer may include polybutadiene. The shell of the MBS-based graft copolymer may include one or more selected from the group consisting of alkyl methacrylate, and alkyl acrylate.

The thermoplastic resin composition may suitably include: an amount of about 13 to 63% by weight of the first polycarbonate; an amount of about 10 to 40% by weight of a polysiloxane-polycarbonate copolymer; an amount of about 10 to 45% by weight of polyester; an amount of about 1.5 to 8.5% by weight of carbon black compounded as a master batch (MB); an amount of about 3 to 15% by weight of a heat resistance improver; and an additive comprising an amount of about 5 to 25% by weight of a gloss reducing agent and an amount of about 1 to 10% by weight of an impact modifier, based on the total weight of the thermoplastic resin composition.

The additive may further include one or more auxiliary agents selected from the group consisting of an inorganic filler, a lubricant, an antioxidant, a light stabilizer, a hydrolysis stabilizer, a release agent, a coloring agent, a ultraviolet stabilizer, an antistatic agent, a conductivity imparting agent, a magnetism imparting agent, a crosslinking agent, an antibacterial agent, a processing aid, an anti-friction agent, an anti-wear agent, and a coupling agent.

The auxiliary agent may comprise an amount of about 0.1 to 2 parts by weight based on 100 parts by weight of the first polycarbonate.

In an aspect, provided is a method for manufacturing a molded article, including: manufacturing a pellet by melting and extruding the thermoplastic resin composition as described herein; and manufacturing a molded article by molding the pellets.

In an aspect, provided is a molded article manufactured by the above manufacturing method in which a 20° (degree) specular glossiness based on ISO 2813 may be about 2.5 to 3.0.

Also provided is a vehicle that includes the molded article as described herein.

Other aspects are disclosed infra.

According to various exemplary embodiments of the present disclosure, a thermoplastic resin composition which satisfies mechanical properties such as impact resistance while having excellent heat resistance, exhibits chemical resistance, hydrolysis resistance, and light resistance may be provided, such that the resin can be used for applications such as automobile interior and exterior materials for low gloss non-painting with excellent injection appearance, and an automobile molded article comprising the same.

The effects of the present disclosure are not limited to the above-mentioned effects. It should be understood that the effects of the present disclosure include all effects that can be inferred from the following description.

### DETAILED DESCRIPTION

The above objects, other objects, features, and advantages of the present disclosure will be readily understood through the following preferred exemplary embodiments. However, the present disclosure is not limited to the exemplary embodiments described herein and may also be specified in other forms. Rather, the exemplary embodiments described herein are provided so that the disclosed contents can be thorough and complete and the spirit of the present disclosure may be sufficiently conveyed to those skilled in the art.

Similar reference numerals have been used for similar components while describing each drawing. In the accompanying drawings, the dimensions of the structures are shown larger than those of the real ones for the clarity of the present disclosure. The terms first, second, etc. may be used to describe various components, but the components should not be limited to the above terms. The terms are used only for the purpose of distinguishing one component from another. For example, a first component may be named as a second component without departing from the scope of the present disclosure, and similarly, the second component may also be named as the first component. The singular expression includes a plurality of expressions unless the context clearly mean otherwise.

In the present specification, it should be understood that the term “include” or “have” is intended to specify the presence of a feature, a number, a step, an operation, a component, a part or combinations thereof described in the specification, and does not preclude the possibility of the presence or addition of one or more other features or numbers, steps, operations, components, parts or combinations thereof in advance. In addition, if a portion such as a layer, a membrane, a region, or a plate is said to be “on” another portion, this includes not only a case where it is “directly above” another portion, but also a case where it has other parts interposed therebetween. Conversely, if a portion such as a layer, a membrane, a region, or a plate is said to be “under” another portion, this includes not only a case where it is “directly under” another portion, but also a case where it has other portions interposed therebetween.

Unless otherwise specified, since all numbers, values, and/or expressions representing components, reaction conditions, polymer compositions, and an amount of mixtures used in the present specification are approximations reflecting various uncertainties of measurements that these numbers essentially occur in obtaining these values from the others, it should be understood that all cases are modified by the term “about”. Further, unless specifically stated or obvious from context, as used herein, the term “about” is understood as within a range of normal tolerance in the art, for example within 2 standard deviations of the mean. “About” can be understood as within 10%, 9%, 8%, 7%. 6%, 5%, 4%, 3%, 2%, 1%, 0.5%, 0.1%, 0.05%, or 0.01% of the stated value. Unless otherwise clear from the context, all numerical values provided herein are modified by the term “about.”

In addition, if the numerical range is disclosed in the present disclosure, this range is continuous, and includes all values from the minimum value to the maximum value including a maximum value in this range unless indicated otherwise. Furthermore, if this range refers to an integer, all integers including the minimum value to the maximum value including a maximum value are included unless otherwise indicated. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Provided herein, inter alia, are thermoplastic resin composition comprising: a first polycarbonate; a polysiloxane-polycarbonate copolymer; polyester; carbon black compounded as a master batch (MB); a heat resistance improver; and an additive, a method for manufacturing a molded article using the thermoplastic resin composition, a molded article manufactured through the manufacturing method, and a vehicle including the molded article.

Hereinafter, compositions contained in the thermoplastic resin composition according to the present disclosure will be each described, and the content relationship of these compositions will be described.

Polycarbonate

Polycarbonate may include an aromatic polycarbonate resin, preferably a thermoplastic aromatic polycarbonate resin.

Polycarbonate may suitably have a viscosity average molecular weight (Mv) of about 15,000 to 40.000, about 17,000 to 30,000, and or particularly about 20,000 to 30,000, measured in a methylene chloride solution at a temperature of about 25° C. When the viscosity average molecular weight of polycarbonate is less than about 15,000, mechanical properties such as impact strength and tensile strength of a molded article may be greatly reduced, and when it is greater than about 40,000, there may occur problems in processing the resin due to an increase in melt viscosity.

Polycarbonate according to the present disclosure may comprise a polymer of Chemical Formula 1 below.

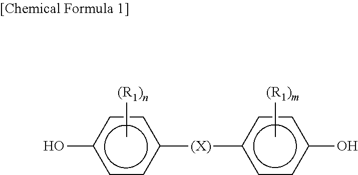

In Chemical Formula 1, X is a linear, branched or cyclic alkylene group, or comprises a linear, branched or cyclic alkylene group comprising a functional group selected from the group consisting of sulfide, ether, sulfoxide, sulfone, ketone, naphthyl, isobutylphenyl, and combinations thereof; each R₁ and R₂ is independently comprise a hydrogen atom, a halogen atom, or an alkyl group; and n and m each comprise an integer of 0 to 4.

The thermoplastic resin composition may include an amount of about 13 to 63% by weight, or particularly about 25 to 55% by weight of a first polycarbonate, based on the total weight of the thermoplastic resin composition. When the content of the first polycarbonate is less than about 13% by weight, the effect of improving properties such as transparency, fluidity, heat resistance, and room-temperature impact strength may be insignificant. When it is greater than about 63% by weight, flame retardancy, low-temperature impact strength, etc. may be reduced.

Further, the thermoplastic resin composition may include a second polycarbonate as included in a master batch including the carbon black. The first polycarbonate and the second polycarbonate may be the same or different. When the first polycarbonate and the second polycarbonate are different, these polymers are different in physical or chemical properties such as polydispersity index (PDI).

Polysiloxane-Polycarbonate Copolymer

The polysiloxane-polycarbonate copolymer may include a copolymer polymer including hydroxy terminated siloxane and polycarbonate.

The polysiloxane-polycarbonate copolymer may suitably have a viscosity average molecular weight of about 15,000 to 200,000, preferably 15,000 to 70,000, measured in a methylene chloride solution at a temperature of about 25° C. When the viscosity average molecular weight is less than about 15,000, the mechanical properties of a molded article may be remarkably reduced, and when it is greater than about 200,000, there may be problems in processing the resin due to an increase in melt viscosity.

The polysiloxane-polycarbonate copolymer may include hydroxy terminated siloxane and polycarbonate at a weight ratio of about 50:50 to 99:1. When the relative content of the siloxane portion is less than the above weight ratio, flame retardancy and low-temperature impact strength may be reduced, and conversely, when the relative content of the siloxane portion is greater than the above weight ratio, physical properties such as transparency, fluidity, heat resistance, and room-temperature impact strength may be reduced due to a decrease in the relative content of the polycarbonate portion, and manufacturing costs may increase.

The polysiloxane-polycarbonate copolymer may comprise polymers of Chemical Formulas 2 and 3 below.

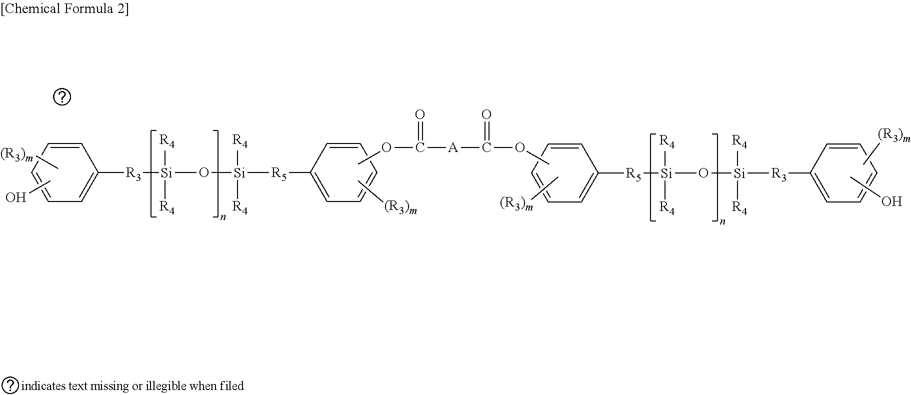

In Chemical Formula 2, each R₃ independently comprises a hydrogen atom, a halogen atom, a hydroxy group, an alkyl group having 1 to 20 carbon atoms, an alkoxy group having 1 to 13 carbon atoms, or an aryl group having 6 to 10 carbon atoms; each R₄ is independently a hydrocarbon group having 1 to 13 carbon atoms or a hydroxy group; each R₅ is independently an alkylene group having 2 to 8 carbon atoms; A is -X- or —NH—X—NH—, wherein X indicates a linear or branched aliphatic group having 1 to 20 carbon atoms, a cycloalkylene group having 3 to 6 carbon atoms, or a mononuclear or polynuclear arylene group having 6 to 30 carbon atoms unsubstituted or substituted with a halogen atom, an alkyl group, an alkoxy group, an aryl group, or a carboxyl group; each m is independently an integer of 0 to 10, and each n is independently an integer of 2 to 1,000.

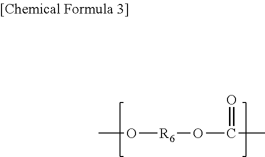

In Chemical Formula 3, R₆ is an alkyl group having 1 to 20 carbon atoms, a cycloalkyl group having 3 to 6 carbon atoms, an alkenyl group having 2 to 13 carbon atoms, an alkoxy group having 1 to 13 carbon atoms, or an aromatic hydrocarbon group having 6 to 30 carbon atoms unsubstituted or substituted with a halogen atom, or a nitro.

The thermoplastic resin composition may include an amount of about 10 to 40% by weight, or particularly about 15 to 40% by weight of the polysiloxane-polycarbonate copolymer, based on the total weight of the thermoplastic resin composition. When the content of the polysiloxane-polycarbonate copolymer is less than about 10% by weight, the effect of improving physical properties such as chemical resistance and impact strength may be insignificant, and when it is greater than about 40% by weight, heat resistance and color reproducibility may be reduced, and tensile strength, flexural strength, flexural modulus, etc. may be reduced.

Polyester

Polyester may have a melting temperature of about 215° C. to 235° C. and an intrinsic viscosity (IV) of about 0.45 dl/g to 1.6 dl/g.

Polyester may comprise one or more selected from the group consisting of polyethylene terephthalate, polypropylene terephthalate, and polybutylene terephthalate.

The thermoplastic resin composition may suitably include an amount of about 10% by weight to 45% by weight of the polyester, or particularly about 10% by weight to 30% by weight of the polyester, based on the total weight of the thermoplastic resin composition. When the content of polyester is less than about 10% by weight, the effect of improving chemical resistance may be insignificant, and when it is greater than about 45% by weight, mechanical properties and color reproducibility may deteriorate.

Carbon Black

Carbon black may be used as being contained in a master batch (MB).

The master batch may suitably include the second polycarbonate and carbon black. For example, the carbon black may be dispersed in the second polycarbonate, and the mixture may be formed into a master batch so that carbon black may be easily dispersed.

The master batch may suitably include an amount of about 10% by weight to 40% by weight of carbon black and an amount of about 60% by weight to 90% by weight of the second polycarbonate, based on the total weight of the master batch. Particularly, the master batch may suitably include an amount of about 15% by weight to 30% by weight of carbon black and an amount of about 70% by weight to 85% by weight of the second polycarbonate, based on the total weight of the master batch. When the content of carbon black in the master batch is less than about 10% by weight, a synergistic effect on light resistance may not be obtained, and when it is greater than about 40% by weight, processability may deteriorate.

The thermoplastic resin composition may include an amount of about 1.5% by weight to 8.5% by weight, or particularly an amount of about 1.5% by weight to 6.5% by weight of the carbon black, or particularly an amount of about 3.5% by weight to 6.5% by weight of the carbon black, based on the total weight of the thermoplastic resin composition. When the content of carbon black is less than about 1.5% by weight, the effect of improving light resistance may be insignificant, and when it is greater than about 8.5% by weight, mechanical properties may deteriorate.

Carbon black may be added in the form of a master batch. When it is added in a form other than the master batch, overall mechanical properties may decrease and light resistance and low glossiness may decrease.

Heat Resistance Improver

The heat resistance improver may suitably include an N-phenylmaleimide compound-vinyl aromatic compound-maleic anhydride copolymer.

The heat resistance improver may include N-phenylmaleimide compound-vinyl aromatic compound-maleic anhydride copolymer that may suitably include an amount of about 44% by weight to 65% by weight of an N-phenylmaleimide compound, an amount of about 34% by weight to 55% by weight of a vinyl aromatic compound, and an amount of about 0.5% by weight to 5% by weight of maleic anhydride, based on the total weight of the heat resistance improver.

The N-phenylmaleimide compound-vinyl aromatic compound-maleic anhydride copolymer may suitably have a glass transition temperature of about 194° C. to 210° C., a weight average molecular weight (Mw) of about 125,000 to 135,000 g/mol, and a flowability (265° C./10 kg) of about 2.2 to 4.1 g/10 min.

The thermoplastic resin composition may suitably include an amount of about 3% by weight to 15% by weight of the heat resistance improver, an amount of about 3% by weight to 12% by weight, an amount of about 3% by weight to 10% by weight, an amount of about 5% by weight to 15% by weight, an amount of about 5% by weight to 12% by weight, or an amount of about 5% by weight to 10% by weight of the heat resistance improver, based on the total weight of the thermoplastic resin composition.

When the content of the heat resistance improver is less than about 3% by weight, the effect of improving heat resistance may be insignificant, and when it is greater than about 15% by weight, impact strength and surface impact may be reduced.

Additive

The additive may comprise a gloss reducing agent and an impact modifier.

The gloss reducing agent may include an ASA-based graft copolymer, and preferably having a core-shell structure.

The ASA-based graft copolymer may suitably include an amount of about 30% by weight to 80% by weight of a core and an amount of about 20% by weight to 70% by weight of a shell, based on the total weight of the ASA-based graft copolymer. The core may include an acrylic and the shell may include a vinyl-based graft copolymer. As a method for polymerizing the ASA-based graft copolymer, a conventional method known in the art may be used. For example, emulsion polymerization, suspension polymerization, etc. may be used, and an emulsion polymerization method may be preferably used in order to increase the average particle diameter of the acrylic rubber constituting the core.

The thermoplastic resin composition may suitably include an amount of about 5% by weight to 25% by weight, or particularly an amount of about 10% by weight to 20% by weight of the gloss reducing agent, based on the total weight of the thermoplastic resin composition. When the content of the gloss reducing agent is less than about 5% by weight, the effect of improving hydrolysis resistance and low glossiness may be insignificant, and when the content of the ASA-based graft copolymer is greater than about 25% by weight, moldability and heat resistance may be reduced.

The impact modifier may comprise an MBS-based graft copolymer, and preferably has a core-shell structure. The core may include polybutadiene, and the shell may include one or more selected from the group consisting of alkyl methacrylate and alkyl acrylate.

When the MBS-based graft copolymer is used as an impact modifier, high color reproducibility and thermal stability may be guaranteed, and there is an advantage in that the process time may be shortened during injection molding.

The thermoplastic resin composition may suitably include an amount of about 1% by weight to 10% by weight, or particularly an amount of about 5% by weight to 10% by weight of the impact modifier, based on the total weight of the thermoplastic resin composition. When the content of the impact modifier is less than about 1% by weight, the low glossiness may be reduced (that is, the glossiness is increased), and the effect of improving impact strength may be insignificant, and when it is greater than about 10% by weight, mechanical properties such as tensile strength, flexural strength, and flexural modulus may deteriorate.

The additive may further comprise, as needed, any one auxiliary agent selected from the group consisting of an inorganic filler, a lubricant, an antioxidant, a light stabilizer, a hydrolysis stabilizer, a release agent, a coloring agent, a ultraviolet stabilizer, an antistatic agent, a conductivity imparting agent, a magnetism imparting agent, a crosslinking agent, an antibacterial agent, a processing aid, an anti-friction agent, an anti-wear agent, and a coupling agent.

The auxiliary agent is not particularly limited as long as it is a material that can be used in the art for a thermoplastic resin composition. For example, examples of the antioxidant may comprise a phenol type antioxidant, a phosphite type antioxidant, a thioether type antioxidant, an amine type antioxidant, etc., examples of the release agent may comprise a fluorine-containing polymer, silicone oil, a metal salt of stearic acid, a metal salt of montanic acid, an ester wax of montanic acid, a polyethylene wax, etc., and examples of the ultraviolet stabilizer may comprise benzophenone, benzotriazole, an amine type ultraviolet stabilizer, etc.

The auxiliary agent may be contained in an amount of about 0.1% by weight to 5% by weight, about 1% by weight to 5% by weight, or particularly about 2% by weight to 4% by weight based on 100% by weight of the total composition.

The thermoplastic resin composition may include: a first polycarbonate; a polysiloxane-polycarbonate copolymer; polyester; carbon black compounded as a master batch (MB); a heat resistance improver; an additive comprising a gloss reducing agent and an impact modifier. The thermoplastic resin composition may suitably include an amount of about 13% by weight to 63% by weight of the first polycarbonate; an amount of about 10% by weight to 40% by weight of a polysiloxane-polycarbonate copolymer; an amount of about 10% by weight to 45% by weight of polyester; an amount of about 1.5% by weight to 8.5% by weight of carbon black compounded as a master batch (MB); an amount of about 3% by weight to 15% by weight of a heat resistance improver; and an additive including an amount of about 5% by weight to 25% by weight of a gloss reducing agent and an amount of about 1% by weight to 10% by weight of an impact modifier, based on the total weight of the thermoplastic resin composition. The master batch may suitably include an amount of about 10% by weight to 40% by weight of carbon black and an amount of about 60% by weight to 90% by weight of the second polycarbonate, based on the total weight of the master batch.

Method for Manufacturing Molded Article

A method for manufacturing a molded article may include manufacturing a pellet by melting and extruding the aforementioned thermoplastic resin composition; and manufacturing a molded article by molding the pellets.

The molding process is not significantly different from the process of manufacturing a general plastic molded article, and examples of molding may comprise injection molding, blow molding, extrusion molding, and thermoforming methods, but is not particularly limited thereto.

The foregoing melting and extrusion processes will not also be particularly limited in the present disclosure, and more specific processes will be dealt with in the following Examples.

Molded Article

The molded article manufactured by the foregoing method for manufacturing a molded article may have excellent mechanical properties. Particularly, in glossiness, the molded article may have a 20° (degree) specular glossiness based on ISO 2813 of about 2.5 to 3.0.

### EXAMPLE

Effective aspects of the thermoplastic resin composition according to various exemplary embodiments of the present disclosure and the molded article manufactured therethrough will be described with reference to the results of Examples and Experimental Example to be described below.

Hereinafter, the present disclosure will be described in detail with reference to the following Examples and Comparative Examples. However, the technical spirit of the present disclosure is not restricted or limited thereby.

The components used in the Examples and Comparative Examples according to the present disclosure are specifically as follows.

(A) A polycarbonate resin: Samyang Corporation 3020 PJ (Mv: 21,000)

(B) A polysiloxane-polycarbonate resin: Samyang Corporation ST4-3022 PJ (Mv: 26,000)

(C) A polyester resin: polybutylene terephthalate (intrinsic viscosity 1.1 dl/g)

(D) An ASA-based graft copolymer with a core/shell structure: LG's L1910

(E) A heat resistance improver: Denka MS-CP

(F-1) An MBS-based impact modifier with a core/shell structure: Kaneka M732

(F-2) A silicone-based impact modifier with a core/shell structure: Mitsubishi Rayon 5-2001

(F-3) An acrylic impact modifier with a core/shell structure: R&Hass EXL2313 (G-1) Carbon black: Raven 2350 Ultra (Birla Carbon) (NSA surface area: 203 m²/g, average particle diameter: 15 nm)

(G-2) A carbon black master batch: After a portion of the polycarbonate resin of (A) (a second polycarbonate resin) and carbon black of (G-1) were allowed to be mixed at a weight ratio of 70:30 so that a mixture was injected into a twin-screw extruder (L/D=48, Φ=25 mm, a melting temperature of about 270° C., and a screw rotation speed of 150 rpm), the mixture was subjected to extrusion, cooling, and cutting processes to prepare a master batch.

### Examples 1 to 11

After a polycarbonate resin (A), a polysiloxane-polycarbonate resin (B), a polyester resin (C), an ASA-based graft copolymer (D), a heat resistance improver (E), an MBS-based impact modifier (F-1), a carbon black master batch (G-2), and other additives were injected into a twin-screw extruder (L/D=48, Φ=251 nm, a melting temperature of about 270° C., and a screw rotation speed of 150 rpm) in the same amounts as in Table 1 below, the mixture was subjected to extrusion, cooling, and cutting processes to prepare pellets of Examples 1 to 11.

TABLE 1

| Composition | | | | | | | | | | | |
|---|---|---|---|---|---|---|---|---|---|---|---|
| (% by | Examples | | | | | | | | | | |
| weight) | 1 | 2 | 3 | 4 | 5 | 6 | 7 | 8 | 9 | 10 | 11 |
| (A) | 35 | 40 | 10 | 45 | 20 | 40 | 20 | 40 | 28 | 38.5 | 33.5 |
| (B) | 15 | 10 | 40 | 15 | 20 | 15 | 15 | 15 | 15 | 15 | 15 |
| (C) | 20 | 20 | 20 | 10 | 30 | 20 | 20 | 20 | 20 | 20 | 20 |
| (D) | 10 | 10 | 10 | 10 | 10 | 5 | 25 | 10 | 10 | 10 | 10 |
| (E) | 8 | 8 | 8 | 8 | 8 | 8 | 8 | 3 | 15 | 8 | 8 |
| (F-1) | 5 | 5 | 5 | 5 | 5 | 5 | 5 | 5 | 5 | 5 | 5 |
| (F-2) | — | — | — | — | — | — | — | — | — | — | — |
| (F-3) | — | — | — | — | — | — | — | — | — | — | — |
| (G-1) | — | — | — | — | — | — | — | — | — | — | — |
| (G-2) | 5 | 5 | 5 | 5 | 5 | 5 | 5 | 5 | 5 | 1.5 | 6.5 |

### Comparative Examples 1 to 15

After a polycarbonate resin (A), a polysiloxane-polycarbonate resin (B), a polyester resin (C), an ASA-based graft copolymer (D), a heat resistance improver (E), impact modifiers (F-1, F-2, and F-3), carbon black (G-1 and G-2), and other additives were injected into a twin-screw extruder (L/D=48, Φ=25 mm, a melting temperature of about 270° C., and a screw rotation speed of 150 rpm) in the same amounts as in Table 2 below, the mixture was subjected to extrusion, cooling, and cutting processes to prepare pellets of Comparative Examples 1 to 15.

TABLE 2

| Com- | | | | | | | | | | | | | | | |
|---|---|---|---|---|---|---|---|---|---|---|---|---|---|---|---|
| position | | | | | | | | | | | | | | | |
| (% by | Comparative Examples | | | | | | | | | | | | | | |
| weight) | 1 | 2 | 3 | 4 | 5 | 6 | 7 | 8 | 9 | 10 | 11 | 12 | 13 | 14 | 15 |
| (A) | 35 | 35 | 50 | 5 | 55 | 5 | 45 | 15 | 43 | 23 | 40 | 31.5 | 40 | 38.5 | 31 |
| (B) | 15 | 15 | — | 45 | 15 | 15 | 15 | 15 | 15 | 15 | 15 | 15 | 15 | 15 | 15 |
| (C) | 20 | 20 | 20 | 20 | — | 50 | 20 | 20 | 20 | 20 | 20 | 20 | 20 | 20 | 20 |
| (D) | 10 | 10 | 10 | 10 | 10 | 10 | — | 30 | 10 | 10 | 10 | 10 | 10 | 10 | 10 |
| (E) | 8 | 8 | 8 | 8 | 8 | 8 | 8 | 8 | — | 20 | 8 | 8 | 8 | 8 | 8 |
| (F-1) | — | — | 5 | 5 | 5 | 5 | 5 | 5 | 5 | 5 | — | 12 | 5 | 5 | 5 |
| (F-2) | 5 | — | — | — | — | — | — | — | — | — | — | — | — | — | — |
| (F-3) | — | 5 | — | — | — | — | — | — | — | — | — | — | — | — | — |
| (G-1) | — | — | — | — | — | — | — | — | — | — | — | — | — | 1.5 | — |
| (G-2) | 5 | 5 | 5 | 5 | 5 | 5 | 5 | 5 | 5 | 5 | 5 | 1.5 | — | — | 9 |

### Experimental Example

After the pellets prepared in the Examples and Comparative Examples above were dried with hot air at 80° C. to 100° C. for 4 hours, injection molding was performed at a cylinder temperature of 250° C. to 280° C. and a mold temperature of 80° C. to prepare specimens, and the physical properties of each of the prepared specimens were measured, and the results are shown in Tables 4 and 5.

The physical properties of each of the prepared specimens were measured by the following methods.

(1) Tensile strength: Evaluation was performed in accordance with ISO 527

(2) Flexural strength: Evaluation was performed in accordance with ISO 178

(3) Flexural modulus: Evaluation was performed in accordance with ISO 178

(4) Impact strength: Evaluation was performed in accordance with ISO 180 (Notch-Izod)

(5) Heat Deflection Temperature (HDT): Evaluation was performed with a load of 1.8 MPa in accordance with ISO 75

(6) Surface impact: Evaluation was performed in accordance with ISO 6603 (specimen thickness: 2 T, drop velocity: 4.4 m/s)

(7) Light resistance: Self-measurement was performed by Samyang Corporation (ATLAS CI 4000, based on an irradiance of 1,050 KJ/m²)

(8) Glossiness: 20° (degree) specular gloss evaluation was performed in accordance with ISO 2813

(9) Hydrolysis resistance: Self-measurement was performed by Samyang Corporation (85R.H, 85° C., 300 hr impact strength reduction rate)

(10) Chemical resistance: A paint material band strip test (7 days) was performed with a tensile specimen in accordance with ASTM D638, and the evaluation intensity values are 1 to 5, and the standards are shown in Table 3 below.

TABLE 3
Chemical resistance

| OK | Edge Crack | Center Crack | Deep Crack | Break |
|---|---|---|---|---|
| 5 | 4 | 3 | 2 | 1 |

TABLE 4

| Measurement | | | | | | | | | | | |
|---|---|---|---|---|---|---|---|---|---|---|---|
| of | Examples | | | | | | | | | | |
| properties | 1 | 2 | 3 | 4 | 5 | 6 | 7 | 8 | 9 | 10 | 11 |
| (1) | 56 | 58 | 52 | 55 | 58 | 55 | 53 | 57 | 52 | 57 | 54 |
| (2) | 84 | 85 | 80 | 83 | 86 | 82 | 84 | 84 | 80 | 85 | 82 |
| (3) | 2,100 | 2,150 | 2,000 | 2,100 | 2,200 | 2,100 | 2,150 | 2,100 | 2,050 | 2,150 | 2,050 |
| (4) | 60 | 58 | 65 | 62 | 56 | 58 | 63 | 62 | 52 | 61 | 58 |
| (5) | 97 | 96 | 97 | 102 | 94 | 98 | 92 | 94 | 103 | 98 | 96 |
| (6) | 55 | 52 | 64 | 56 | 50 | 51 | 57 | 56 | 50 | 57 | 53 |
| (7) | 1.8 | 1.8 | 1.7 | 1.6 | 2.9 | 1.8 | 1.7 | 1.8 | 1.8 | 2.7 | 1.5 |
| (8) | 2.8 | 2.7 | 2.8 | 2.6 | 3 | 2.9 | 2.6 | 2.8 | 2.7 | 3 | 2.5 |
| (9) | 14 | 17 | 11 | 13 | 18 | 21 | 7 | 13 | 16 | 14 | 15 |
| (10) | 5 | 5 | 5 | 4 | 5 | 5 | 5 | 5 | 5 | 5 | 5 |

```
  (1): Tensile strength,
  (2): Flexural strength,
  (3): Flexural modulus,
  (4): Impact strength,
  (5): Heat deflection temperature,
  (6): Surface impact,
  (7): Light resistance,
  (8): Glossiness,
  (9): Hydrolysis resistance,
(10): Chemical resistance
```

TABLE 5

| Measurement | | | | | | | | | | | | | | | |
|---|---|---|---|---|---|---|---|---|---|---|---|---|---|---|---|
| of | Comparative Examples | | | | | | | | | | | | | | |
| properties | 1 | 2 | 3 | 4 | 5 | 6 | 7 | 8 | 9 | 10 | 11 | 12 | 13 | 14 | 15 |
| (1) | 54 | 55 | 60 | 45 | 53 | 61 | 56 | 55 | 58 | 47 | 64 | 50 | 58 | 52 | 47 |
| (2) | 80 | 82 | 87 | 71 | 79 | 86 | 83 | 85 | 84 | 78 | 89 | 74 | 83 | 78 | 72 |
| (3) | 2,100 | 2,100 | 2,200 | 1,800 | 2,000 | 2,250 | 2,050 | 2,150 | 2,150 | 1,900 | 2,300 | 1,950 | 2,100 | 2,000 | 1,850 |
| (4) | 57 | 58 | 50 | 65 | 62 | 47 | 56 | 65 | 69 | 42 | 15 | 69 | 57 | 59 | 48 |
| (5) | 96 | 96 | 97 | 95 | 120 | 90 | 99 | 88 | 85 | 122 | 98 | 93 | 96 | 95 | 95 |
| (6) | 52 | 54 | 48 | 67 | 57 | 42 | 48 | 60 | 69 | 38 | 38 | 67 | 57 | 50 | 49 |
| (7) | 2.4 | 2.2 | 2.2 | 1.7 | 1.5 | 3.8 | 2.5 | 1.7 | 1.8 | 1.9 | 1.8 | 2.4 | 4.5 | 2.4 | 1.4 |
| (8) | 3.2 | 3.3 | 2.9 | 3.4 | 3.2 | 2.7 | 3.1 | 2.4 | 2.8 | 2.9 | 3.3 | 3 | 3.9 | 2.9 | 2.4 |
| (9) | 15 | 15 | 19 | 10 | 14 | 22 | 28 | 6 | 12 | 19 | 14 | 16 | 14 | 15 | 15 |
| (10) | 5 | 4 | 3 | 5 | 1 | 5 | 4 | 5 | 5 | 4 | 5 | 3 | 3 | 5 | 5 |

```
  (1): Tensile strength,
  (2): Flexural strength,
  (3): Flexural modulus,
  (4): Impact strength,
  (5): Heat deflection temperature,
  (6): Surface impact,
  (7): Light resistance,
  (8): Glossiness,
  (9): Hydrolysis resistance,
(10): Chemical resistance
```

As shown in the experimental results of the Examples and Comparative Examples in Tables 4 and 5 above, the thermoplastic resin compositions according to Examples 1 to 11 had excellent balanced properties in all of mechanical properties such as chemical resistance, tensile strength, flexural strength, impact strength, and surface impact, light resistance, hydrolysis resistance, and low glossiness compared to the thermoplastic resin compositions presented in the Comparative Examples, and specifically realized excellent light resistance of 3 or less and excellent low glossiness at a level of 3 or less in all compositions.

Meanwhile, in Comparative Examples 1 and 2 that the glossiness was increased by using impact modifiers other than the MBS-based impact modifier.

Comparative Examples 3 and 5 showed very low chemical resistance values, which were insufficient to be applied as materials for non-painting, and an impact modifier was not added to Comparative Example 11 so that the impact strength was greatly reduced.

The contents of the polysiloxane-polycarbonate resin and the impact modifier in Comparative Examples 4 and 12 were so high that tensile strength, flexural strength, and flexural modulus were significantly lowered, and it can be seen that the content of the polyester resin in Comparative Example 6 was higher than in Example 1 so that impact strength and light resistance were lowered.

The ASA-based graft copolymer having a core/shell structure was not added to Comparative Example 7 so that hydrolysis resistance is greatly lowered compared to Example 1, and conversely, the ASA-based graft copolymer having a core/shell structure was added in excess to Comparative Example 8 so that heat resistance was lowered.

The heat resistance improver was not added to Comparative Example 9 so that the heat deflection temperature was lowered compared to Example 1, and conversely, the heat resistance improver was added in excess to Comparative Example 10 so that impact strength and surface impact were greatly deteriorated.

Comparative Example 14 that dispersibility was reduced by adding carbon black, which was not in a master batch form, so that overall mechanical properties, light resistance, and gloss resistance were reduced.

A carbon black master batch was not added to Comparative Example 13 so that the light resistance was reduced, and the carbon black master batch was added in excess to Comparative Example 15 so that overall low mechanical properties were exhibited.

Therefore, the thermoplastic resin composition can obtain improved heat resistance, chemical resistance, light resistance, hydrolysis resistance, low glossiness, and mechanical properties even without a separate post-treatment process to improve chemical resistance of the molded article. Such a thermoplastic resin composition would be suitable as a molded article for automobiles and electric and electronic uses, particularly, as automobile interior materials for non-painting.

As the Experimental Example and Examples have been described in detail above, the scope of rights of the present disclosure is not limited to the above-described Experimental Example and Examples, and various modifications and improved forms of those skilled in the art using the basic concept of the present disclosure defined in the following claims are also included in the scope of rights of the present disclosure.

What is claimed is:

1. A thermoplastic resin composition comprising:
a first polycarbonate;
a polysiloxane-polycarbonate copolymer;
a polyester;
a master batch comprising a carbon black;
a heat resistance improver; and
an additive.

2. The thermoplastic resin composition of claim 1, wherein the first polycarbonate comprises a thermoplastic aromatic polycarbonate having a viscosity average molecular weight (Mv) of about 15,000 to 40,000.

3. The thermoplastic resin composition of claim 1, wherein the first polycarbonate comprises a polymer of the following Chemical Formula 1: 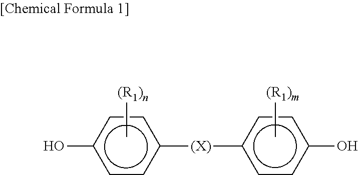
wherein in Chemical Formula 1:
X comprises a linear, branched or cyclic alkylene group, or a linear, branched or cyclic alkylene group comprising a functional group selected from the group consisting of sulfide, ether, sulfoxide, sulfone, ketone, naphthyl, isobutylphenyl, and combinations thereof;
each R₁ and R₂ is independently a hydrogen atom, a halogen atom, or an alkyl group; and
each n and m is independently an integer of 0 to 4.

4. The thermoplastic resin composition of claim 1, wherein the polysiloxane-polycarbonate copolymer has a viscosity average molecular weight (Mv) of about 15,000 to 200,000 and comprises hydroxy-terminated siloxane and polycarbonate at a weight ratio of about 50:50 to 99:1.

5. The thermoplastic resin composition of claim 1, wherein the polysiloxane-polycarbonate copolymer comprises polymers of the following Chemical Formulas 2 and 3: 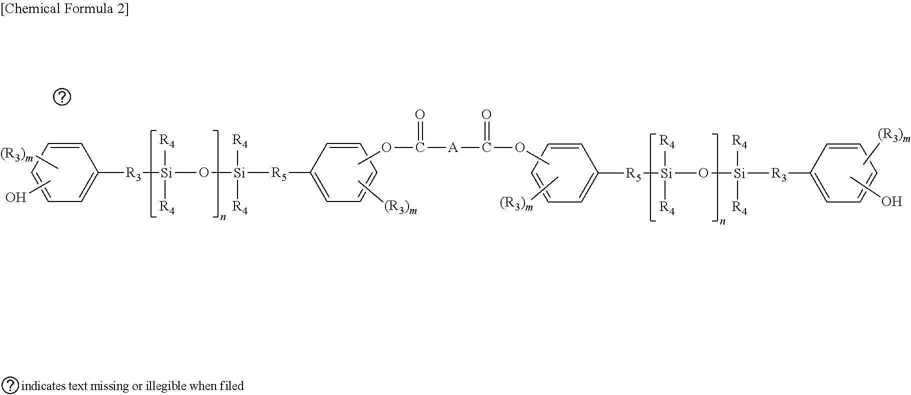
wherein in Chemical Formula 2:
each R₃ is independently a hydrogen atom, a halogen atom, a hydroxy group, an alkyl group having 1 to 20 carbon atoms, an alkoxy group having 1 to 13 carbon atoms, or an aryl group having 6 to 10 carbon atoms
each R₄ is independently a hydrocarbon group having 1 to 13 carbon atoms or a hydroxy group;
each R₅ is independently an alkylene group having 2 to 8 carbon atoms;
A is to -X- or —NH—X—NH—, where X is independently a linear or branched aliphatic group having 1 to 20 carbon atoms, a cycloalkylene group having 3 to 6 carbon atoms, or a mononuclear or polynuclear arylene group having 6 to 30 carbon atoms unsubstituted or substituted with a halogen atom, an alkyl group, an alkoxy group, an aryl group, or a carboxyl group, m independently comprises an integer of 0 to 10 and n independently comprises an integer of 2 to 1,000. 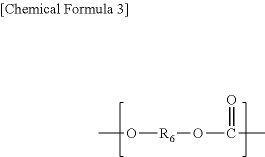
wherein in Chemical Formula 3:
R₆ is an alkyl group having 1 to 20 carbon atoms, a cycloalkyl group having 3 to 6 carbon atoms, an alkenyl group having 2 to 13 carbon atoms, an alkoxy group having 1 to 13 carbon atoms, or an aromatic hydrocarbon group having 6 to 30 carbon atoms unsubstituted or substituted with a halogen atom, or a nitro group.

6. The thermoplastic resin composition of claim 1, wherein the polyester has a melting temperature of about 215° C. to 235° C. and an intrinsic viscosity (IV) of about 0.45 dig to 1.6 dl/g.

7. The thermoplastic resin composition of claim 1, wherein the polyester comprises one or more selected from the group consisting of polyethylene terephthalate, polypropylene terephthalate, and polybutylene terephthalate.

8. The thermoplastic resin composition of claim 1, wherein the master batch comprises the carbon black and a second polycarbonate.

9. The thermoplastic resin composition of claim 8, wherein the master batch comprises an amount of about 10% by weight to 40% by weight of carbon black and an amount of about 60% by weight to 90% by weight of the second polycarbonate, based on the total weight of the master batch.

10. The thermoplastic resin composition of claim 1, wherein the heat resistance improver comprises an N-phenylmaleimide compound-vinyl aromatic compound-maleic anhydride copolymer.

11. The thermoplastic resin composition of claim 1, wherein the heat resistance improver comprises an N-phenylmaleimide compound-vinyl aromatic compound-maleic anhydride copolymer, and the N-phenylmaleimide compound-vinyl aromatic compound-maleic anhydride copolymer comprises an amount of about 44% by weight to 65% by weight of an N-phenylmaleimide compound, an amount of about 34% by weight to 55% by weight of a vinyl aromatic compound, and an amount of about 0.5% by weight to 5% by weight of maleic anhydride, based on the total weight of the heat resistance improver.

12. The thermoplastic resin composition of claim 1, wherein the additive comprises a gloss reducing agent and an impact modifier.

13. The thermoplastic resin composition of claim 12, wherein the gloss reducing agent comprises an ASA-based graft copolymer having a core-shell structure, the ASA-based graft copolymer comprises an amount of about 30% by weight to 80% by weight of a core and an amount of about 20% by weight to 70% by weight of a shell, based on the total weight of the ASA-based graft copolymer, wherein the core of the ASA-based graft copolymer comprises an acrylic rubber, and wherein the shell of the ASA-based graft copolymer comprises a vinyl-based graft copolymer.

14. The thermoplastic resin composition of claim 12, wherein the impact modifier comprises an MBS-based graft copolymer having a core-shell structure, wherein the core of the MBS-based graft copolymer comprises polybutadiene, and wherein the shell of the MBS-based graft copolymer comprises one or more selected from the group consisting of alkyl methacrylate, alkyl acrylate, and a combination thereof.

15. The thermoplastic resin composition of claim 1, wherein the composition comprises an amount of about 13% by weight to 63% by weight of the first polycarbonate, an amount of about 10% by weight to 40% by weight of a polysiloxane-polycarbonate copolymer, an amount of about 10% by weight to 45% by weight of polyester, an amount of about 1.5% by weight to 8.5% by weight of carbon black in the master batch (MB), an amount of about 3% by weight to 15% by weight of a heat resistance improver, and an additive comprising an amount of about 5% by weight to 25% by weight of a gloss reducing agent and an amount of about 1% by weight to 10% by weight of an impact modifier, based on the total weight of the thermoplastic resin composition.

16. The thermoplastic resin composition of claim 1, wherein the additive further comprises one or more auxiliary agents selected from the group consisting of an inorganic filler, a lubricant, an antioxidant, a light stabilizer, a hydrolysis stabilizer, a release agent, a coloring agent, a ultraviolet stabilizer, an antistatic agent, a conductivity imparting agent, a magnetism imparting agent, a crosslinking agent, an antibacterial agent, a processing aid, an anti-friction agent, an anti-wear agent, and a coupling agent.

17. The thermoplastic resin composition of claim 16, wherein the auxiliary agent comprises an amount of about 0.1 parts by weight to 2 parts by weight based on 100 parts by weight of the first polycarbonate.

18. A method for manufacturing a molded article, comprising:
forming a pellet by melting and extruding the thermoplastic resin composition of claim 1; and
manufacturing a molded article by molding the pellets.

19. A molded article manufactured by the manufacturing method of claim 18, wherein a 20° (degree) specular glossiness based on ISO 2813 is about 2.5 to 3.0.

20. A vehicle comprising the molded article in claim 19.
